(19) United States
(12) Patent Application Publication
(10) Pub. No.: US 2023/0331882 A1
(43) Pub. Date: Oct. 19, 2023

(54) POLYPROPYLENE POLYMER HAVING ULTRA-HIGH MELT FLOW RATE

(71) Applicant: W. R. Grace & Co.-Conn., Columbia, MD (US)

(72) Inventor: Jan Van Egmond, Columbia, MD (US)

(73) Assignee: W. R. Grace & Co.-Conn., Columbia, MD (US)

(21) Appl. No.: 18/044,369

(22) PCT Filed: Sep. 9, 2021
(86) PCT No.: PCT/US2021/049547

§ 371 Date: Mar. 7, 2023

Related U.S. Application Data
(60) Provisional application No. 63/075,861, filed on Sep. 9, 2020.

(51) Int. Cl. C08F 110/06

(52) U.S. Cl. CPC C08F 110/06

(57) ABSTRACT

Olefin polymers are produced having an ultra-high melt flow rate. The olefin polymers can be used to produce meltblown fibers and meltblown webs, which can then be incorporated into protective apparel. The polyolefin polymer is produced using a Ziegler-Natta catalyst and without having to use peroxides in order to obtain the high melt flow rate.

### RELATED APPLICATIONS

The present application is based on, and claims priority to, U.S. Provisional Patent Application Ser. No. 63/075,861 filed Sep. 9, 2020, which is incorporated herein by reference.

### BACKGROUND

Polyolefin polymers are used in numerous and diverse applications and fields. Polyolefin polymers, for instance, are thermoplastic polymers that can be easily processed. The polyolefin polymers can also be recycled and reused. Polyolefin polymers are formed from hydrocarbons, such as ethylene and alpha-olefins, which are obtained from petrochemicals and are abundantly available.

Polypropylene polymers, which are one type of polyolefin polymer, generally have a linear structure based on a propylene monomer. Polypropylene polymers can have various different stereospecific configurations. Polypropylene polymers, for example, can be isotactic, syndiotactic, and atactic. Isotactic polypropylene is perhaps the most common form and can be highly crystalline. Polypropylene polymers that can be produced include homopolymers, modified polypropylene polymers, and polypropylene copolymers which include polypropylene terpolymers. By modifying the polypropylene or copolymerizing the propylene with other monomers, various different polymers can be produced having desired properties for a particular application.

Currently, there is a particular demand and need for polypropylene polymers having a very high melt flow rate. The melt flow rate of a polymer generally indicates the amount of molten polymer that flows over a period of time at a particular temperature and load. Higher melt flow rates can indicate that the polymer can be easily processed, especially during extrusion, injection molding, and during the formation of fibers and films. High melt flow rate polypropylene polymers are particularly well suited to producing meltblown webs. Meltblown nonwoven webs are generally formed from a molten thermoplastic polymer that is extruded through a plurality of fine, usually circular, dye capillaries as molten fibers. As the fibers are formed, the fibers contact a high velocity gas, such as air, that attenuates the fibers to reduce their diameter. The meltblown fibers are then deposited onto a collecting surface that forms a web of randomly dispersed meltblown fibers. The meltblown fibers can be continuous or discontinuous. Meltblown webs are particularly well suited for use in filtration applications.

For example, meltblown webs can be incorporated into face masks that are designed to cover the nose and mouth of the wearer. When incorporated into a face mask, meltblown webs are well suited to protecting the wearer by preventing the passage of microorganisms, such as viruses, and other contaminants. Due to the coronavirus pandemic, face masks are now being worn not only by medical professionals, but also by office workers, industrial workers, students, and consumers in virtually all public places.

In the past, in order to produce polypropylene polymers having high melt flow rates for use in producing meltblown webs, the polymers were formed using a metallocene catalyst, or alternatively, the polymer was subjected to peroxide cracking. When using a metallocene catalyst, which are also referred to as single site catalysts, the polymerization process can be relatively slow and somewhat inefficient in that the raw material utilization is low. Further, transitioning the equipment between the use of a Ziegler-Natta catalyst and a metallocene catalyst to produce the polymers can be time consuming and expensive. In addition, metallocene catalyst can be susceptible to reactor operability problems and are not compatible with any known activity limiting agents. Metallocene catalysts can also be sensitive to raw material impurities.

Peroxide cracking technology to produce high melt flow high rate polypropylene polymers also has various drawbacks. Peroxide, for instance, can be expensive. Further, peroxide feed during the process must be carefully controlled so that enough peroxide is fed to achieve stable production of the high melt flow rate polymer. In addition, unreacted peroxide can remain in the final material that causes degradation over time. Finally, peroxide cracking can result in unwanted volatiles that may need to be removed through a thermal oxidation process in order to comply with environmental regulations.

In view of the above, a need currently exists for a more efficient process for producing high melt flow rate polypropylene polymers. A need also exists for polypropylene polymer compositions containing a high melt flow rate polypropylene polymer that can be used to produce all different types of articles including meltblown webs.

### SUMMARY

The present disclosure is generally directed to a process for producing high melt flow rate polyolefin polymers, and to the polymers produced by the process. The high melt flow rate polyolefin polymers can be used in numerous and diverse applications. For instance, the high melt flow rate polymers are particularly well suited to producing extremely fine fibers, such as meltblown fibers. In this regard, the present disclosure is also directed to fibers made from the polymer and to nonwoven webs made from the fibers. In one aspect, the high melt flow rate polymer of the present disclosure can be used to produce meltblown webs that are then incorporated into a face mask for providing protection against airborne microorganisms and contaminants.

For example, in one embodiment, the present disclosure is directed to a polymer composition comprising a polypropylene polymer. The polypropylene polymer has a melt flow rate of greater than about 900 g/10 min, such as greater than about 1000 g/10 min, such as greater than about 1400 g/10 min, such as greater than about 1800 g/10 min, such as greater than about 2200 g/10 min. The melt flow rate of the polypropylene polymer can generally be less than about 9000 g/10 min, such as less than about 7000 g/10 min, such as less than about 4000 g/10 min. The polypropylene polymer has a molecular weight distribution of greater than about 2.5, such as from about 3 to about 13, such as from about 3.5 to about 12. In addition, the polypropylene polymer is free of any peroxides. In one aspect, the polypropylene polymer is a polypropylene homopolymer.

The polypropylene polymer of the present disclosure not only has a very high melt flow rate, but also can have a controlled amount of xylene soluble content. For instance, the polypropylene polymer can have a xylene soluble content of from about 6% by weight to about 2% by weight including all increments of 0.1% therebetween. In one aspect, the xylene soluble content is less than about 6%, such as less than about 4%, such as less than about 3.5%, such as less than about 3%, such as less than about 2.5%, such as less than about 2%. Lower xylene soluble content may offer processing advantages while higher amounts may produce nonwovens with a softer feel.

The polypropylene polymer of the present disclosure can have a weight averaged molecular weight (Mw) of less than about 100,000 g/mol, such as less than about 80,000 g/mol and generally greater than about 20,000 g/mol, such as greater than about 40,000 g/mol. The polypropylene polymer of the present disclosure can have a number average molecular weight (Mn) of less than about 10,000 g/mol.

In accordance with the present disclosure, the polypropylene polymer can be Ziegler-Natta catalyzed, or, in other words, produced in the presence of a Ziegler-Natta catalyst. In one aspect, the Ziegler-Natta catalyst can include an internal electron donor comprising a substituted phenylene diester.

The Ziegler-Natta catalyst can comprise a solid catalyst component, a selectivity control agent, and optionally an activity limiting agent. The solid catalyst component can comprise a magnesium moiety, a titanium moiety, and an internal electron donor. The internal electron donor can be as described above or can be a phthalate compound. In one aspect, the selectivity control agent comprises an organosilicon compound. For instance, the selectivity control agent can comprise propyltriethoxysilane, diisobutyldimethoxysilane, n-propyltrimethoxysilane, or mixtures thereof. In one aspect, the activity limiting agent (ALA) comprises isopropyl myristate or pentyl valerate (PV).

In one aspect, the reactor temperature can be increased for increasing the melt flow rate, reducing the weight average molecular weight and reducing the molecular weight distribution. The above properties can facilitate the fiber blowing process during the production of meltblown webs. The polymer produced from the process is capable of producing fibers at ultra low deniers and/or at higher processing speeds. In addition, nonwoven webs made from the polymer are dimensionally stable and do not exhibit necking during production and handling.

In one aspect, the solid catalyst component may further comprise an organosilicon compound and/or an epoxy compound. In still another aspect, the solid catalyst component can include an organophosphorous compound.

As described above, the polymer composition of the present disclosure is particularly well suited to producing fibers and films. Fibers can be produced according the present disclosure, such as meltblown fibers, having a diameter of less than about 5 microns, such as less than about 2 microns, such as less than about 1 micron, such as less than about 0.5 microns. Meltblown webs can be made from the fibers. The meltblown webs can be used to construct all different types of products, including face masks.

The present disclosure is also directed to a process for producing olefin polymers. The process includes polymerizing a propylene monomer in the presence of a Ziegler-Natta catalyst. The catalyst can include a solid catalyst component, a selectivity control agent, and optionally an activity limiting agent. The solid catalyst component can comprise a magnesium moiety, a titanium moiety, and an internal electron donor. The selectivity control agent can comprise an organosilicon compound. The process can produce a polypropylene polymer having a melt flow rate of greater than about 900 g/10 min. In addition, the process can be carried out without using any peroxides during the formation of the polymer.

In one aspect, the hydrogen ratio to other components in the reactor may be relatively high. Increasing the hydrogen ratio can increase the melt flow rate of the polymer being produced. The xylene solubles is controlled by changing the amount of external electron donor present, which is the amount of both the selectivity control agent and activity limiting agent. For higher melt flows with low xylene solubles, more external electron donor may be fed to the reactor. In one aspect, the external electron donor mix can include a mixture of pentyl valerate and propyltriethoxysilane at a molar ratio of about 50:50 to about 70:30. Reactor temperature can be at 72 C or higher, such as at 80 C to 90 C.

One problem typically encountered in the past as the melt flow rate is increased is the production of higher fine levels in the resin powder. Polymers made according to the present disclosure, however, can contain fines in an amount less than about 8% by weight, such as less than about 7% by weight, such as less than about 6% by weight.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figure.

FIG. 1 is a perspective view of a face mask that may be made from the polymer composition of the present disclosure.

FIG. 2 is a graphical representation of some of the results obtained in the examples below and illustrates the relationship between melt flow rate and H2/C3 molar ratio.

FIG. 3 is a graphical representation of some of the results obtained in the examples below and illustrates the relationship between melt flow rate and xylene solubles; and

FIG. 4. is a graphical representation of some of the results obtained in the examples below and illustrates the relationship between fines and melt flow rate.

### DEFINITIONS AND TESTING PROCEDURES

Melt flow rate (MFR), as used herein, is measured in accordance with the ASTM D1238 test method at 230° C. with a 2.16 kg weight for propylene-based polymers. The melt flow rate can be measured in pellet form or on the reactor powder. When measuring the reactor powder, a stabilizing package can be added including 2000 ppm of CYANOX 2246 antioxidant (methylenebis(4-methyl-6-tert-butylphenol) 2000 ppm of IRGAFOS 168 antioxidant (tris(2,4-di-tert-butylphenyl)phosphite) and 1000 ppm of acid scavenger ZnO.

For high melt flow rate polymers, the testing die orifice may be smaller as indicated below:

| | |
|---|---|
| Equipment | Tungsten carbide large orifice 2.0955 ± |
| | 0.0051 mm (0.0825 ± 0.0002″) I.D. × |
| | 8.000 ± 0.025 mm (0.315 ± 0.001″) long |
| | Tungsten carbide small orifice 1.0490 ± |
| | 0.0051 mm (0.0413 ± 0.0002″) I.D. × |
| | 4.000 ± 0.025 mm (0.1575 ± 0.001″) long |

Position the piston and die in the
cylinder and seat firmly on the base plate.
Maintain the temperature for at least 15 minutes before beginning a
test. When equipment is used repetitiously, it should not be necessary to
heat the piston and die for 15 min.
For Polypropylene materials having a melt index greater than 50,
the small orifice is used.

Calculations for polypropylene polymers:

| Step | Action |
|---|---|
| 1 | $1/4 inch timing interval with large die , Melt Flow = \frac{200}{TestTime}$ |
| 2 | $One inch timing interval with large die , Melt Flow = \frac{800}{TestTime}$ |
| 3 | $1/4 inch timing interval with small die , Melt Flow = \frac{1600}{TestTime}$ |
| 4 | $One inch timing interval with small die , Melt Flow = \frac{6400}{TestTime}$ |

Particle size can be measured using a sieve test. The sieve test is conducted on a GRADEX Particle Size Analyzer commercially available from Rotex Global. Average particle size based on weight fractions is determined from the particle size distribution obtained from the GRADEX Particle Size Analyzer.

Fines is defined as the weight fraction of polymer particles that pass through the GRADEX 120 mesh (125 microns).

Xylene solubles (XS) is defined as the weight percent of resin that remains in solution after a sample of polypropylene random copolymer resin is dissolved in hot xylene and the solution is allowed to cool to 25° C. This is also referred to as the gravimetric XS method according to ASTM D5492-06 using a 60 minute precipitation time and is also referred to herein as the “wet method”.

The ASTM D5492-06 method mentioned above may be adapted to determine the xylene soluble portion. In general, the procedure consists of weighing 2 g of sample and dissolving the sample in 200 ml o-xylene in a 400 ml flask with 24/40 joint. The flask is connected to a water cooled condenser and the contents are stirred and heated to reflux under nitrogen (N2), and then maintained at reflux for an additional 30 minutes. The solution is then cooled in a temperature controlled water bath at 25° C. for 60 minutes to allow the crystallization of the xylene insoluble fraction. Once the solution is cooled and the insoluble fraction precipitates from the solution, the separation of the xylene soluble portion (XS) from the xylene insoluble portion (XI) is achieved by filtering through 25 micron filter paper. One hundred ml of the filtrate is collected into a pre-weighed aluminum pan, and the o-xylene is evaporated from this 100 ml of filtrate under a nitrogen stream. Once the solvent is evaporated, the pan and contents are placed in a 100° C. vacuum oven for 30 minutes or until dry. The pan is then allowed to cool to room temperature and weighed. The xylene soluble portion is calculated as XS (wt %)=[(m3−m2)*2/m1]*100, where m1 is the original weight of the sample used, m2 is the weight of empty aluminum pan, and m3 is the weight of the pan and residue (the asterisk, *, here and elsewhere in the disclosure indicates that the identified terms or values are multiplied).

XS can also be measured according to the Viscotek method, as follows: 0.4 g of polymer is dissolved in 20 ml of xylenes with stirring at 130° C. for 60 minutes. The solution is then cooled to 25° C. and after 60 minutes the insoluble polymer fraction is filtered off. The resulting filtrate is analyzed by Flow Injection Polymer Analysis using a Viscotek ViscoGEL H-100-3078 column with THF mobile phase flowing at 1.0 ml/min. The column is coupled to a Viscotek Model 302 Triple Detector Array, with light scattering, viscometer and refractometer detectors operating at 45° C. Instrument calibration is maintained with Viscotek PolyCAL™ polystyrene standards. A polypropylene (PP) homopolymer, such as biaxially oriented polypropylene (BOPP) grade Dow 5D98, is used as a reference material to ensure that the Viscotek instrument and sample preparation procedures provide consistent results. The value for the reference polypropylene homopolymer, such as 5D98, is initially derived from testing using the ASTM method identified above.

The weight average molecular weight (Mw), the number average molecular weight (Mn), the molecular weight distribution (Mw/Mn) (also referred to as “MWD”) and higher average molecular weights (Mz and Mz+1) are measured by GPC according to the Gel Permeation Chromatography (GPC) Analytical Method for Polypropylene. The polymers are analyzed on Polymer Char High Temperature GPC with IR5 MCT (Mercury Cadmium Telluride-high sensitivity, thermoelectrically cooled IR detector), Polymer Char four capillary viscometer, a Wyatt 8 angle MALLS and three Agilent Plgel Olexis (13 um). The oven temperature is set at 150° C. The solvent is nitrogen purged 1,2,4-trichlorobenzene (TCB) containing ″200 ppm 2,6-di-t-butyl-4-methylphenol (BHT). The flow rate is 1.0 mL/min and the injection volume was 200 μl. A 2 mg/mL sample concentration is prepared by dissolving the sample in N2 purged and preheated TCB (containing 200 ppm BHT) for 2 hrs at 160° C. with gentle agitation.

The GPC column set is calibrated by running twenty narrow molecular weight distribution polystyrene standards. The molecular weight (MW) of the standards ranges from 266 to 12,000,000 g/mol, and the standards were contained in 6 “cocktail” mixtures. Each standard mixture has at least a decade of separation between individual molecular weights. The polystyrene standards are prepared at 0.005 g in 20 mL of solvent for molecular weights equal to or greater than 1,000,000 g/mol and 0.001 g in 20 mL of solvent for molecular weights less than 1,000,000 g/mol. The polystyrene standards are dissolved at 160° C. for 60 min under stirring. The narrow standards mixtures are run first and in order of decreasing highest molecular weight component to minimize degradation effect. A logarithmic molecular weight calibration is generated using a fourth-order polynomial fit as a function of elution volume. The equivalent polypropylene molecular weights are calculated by using following equation with reported Mark-Houwink coefficients for polypropylene (Th. G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N. Y. Hellman, P. M. Muglia, Macromolecules, 4, 507 (1971)):

$${M}_{pp} = {( \frac{{K}_{\text{?}} {M}_{\text{?}}^{\text{?}}}{{K}_{pp}} )}^{\text{?}}$$

$$\text{?} \text{indicates text missing or illegible when filed}$$

where Mpp is PP equivalent MW, MPS is PS equivalent MW, log K and a values of Mark-Houwink coefficients for PP and PS are listed below .

TABLE 2

| Polymer | A | Log K |
|---|---|---|
| Polypropylene | 0.725 | −3.721 |
| Polystyrene | 0.702 | −3.900 |

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a process for producing high melt flow rate polyolefin polymers, particularly polypropylene polymers including polypropylene homopolymers, polypropylene random copolymers and polypropylene block copolymers. Through the process of the present disclosure, polypropylene polymers can be produced having melt flow rates of greater than about 900 g/10 min, such as greater than about 1200 g/10 min, such as greater than about 1500 g/10 min, such as greater than about 1800 g/10 min, such as greater than about 2200 g/10 min, without having to use a single site catalyst and/or without having to use any peroxides. The melt flow rate can be up to about 7000 g/10 min. Thus, the process of the present disclosure allows for the production of very high melt flow rate polypropylene polymers in a very efficient manner. The present disclosure is also directed to the polyolefin polymers made from the process.

Polyolefin polymers, such as polypropylene polymers, with a very high melt flow rate are well suited for use in various different applications in order to produce various different articles and products. High melt flow rate polymers generally have excellent flow properties that make the polymers easy to process, even in extruding or molding processes with very small dimensions. High melt flow rate polyolefin polymers, for instance, are well suited for forming small fibers and thin films. For example, polyolefin polymers made according to the present disclosure are particularly well suited to forming meltblown fibers and meltblown nonwoven webs. Such fibers can be continuous or discontinuous and can have fiber diameters of less than about 5 microns, such as less than about 3 microns, such as less than about 2 microns, such as less than about 1 micron. Meltblown nonwoven webs made from the fibers have excellent filtration properties making them well suited for use as a barrier layer. For example, meltblown webs made according to the present disclosure can make an excellent barrier to fluids, airborne contaminants, and microorganisms, such as viruses. Consequently, meltblown webs made according to the present disclosure are particularly well suited for incorporation into protective garments and apparel.

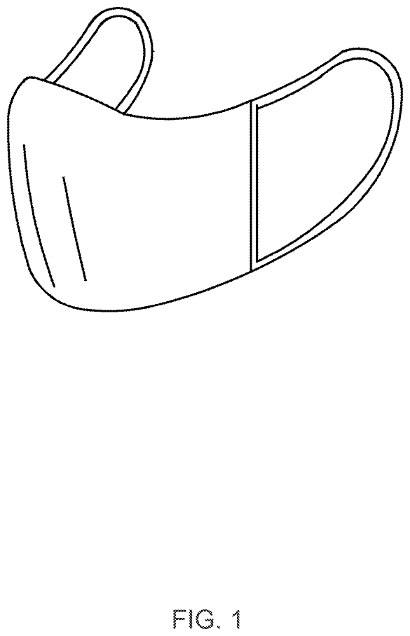

For instance, referring to FIG. 1, one embodiment of a face mask 10 that can be made using a meltblown web of the present disclosure is illustrated. The face mask 10 includes a body portion 12 attached to straps 14 and 16. Strap 14 and 16 are designed to extend around the ears of a user for maintaining the body portion 12 over the nose and mouth of the wearer. The body portion 12 can be made from the meltblown web of the present disclosure. For instance, the body portion 12 can be made from a single layer of meltblown material. Alternatively, the meltblown web of the present disclosure can be one of several layers used to form the body portion 12. For example, in one aspect, the body portion 12 can include the meltblown layer of the present disclosure positioned between two outer layers.

The polypropylene polymer of the present disclosure, which can be a polypropylene homopolymer, is produced using a Ziegler-Natta catalyst. The catalyst generally includes a solid catalyst component in combination with a selectively control agent. Optionally, the catalyst can also include an activity limiting agent. The catalyst is activated during polymerization using a cocatalyst. The solid catalyst component can vary depending upon the particular application. In general, the solid catalyst component contains a magnesium moiety, a titanium moiety, and an internal electron donor. In one aspect, the solid catalyst component can optionally include an organic phosphorous compound, an organosilicon compound, and an epoxy compound. The internal electron donor can comprise a phthalate compound or a substituted phenylene diester.

The selectivity control agent used in accordance with the present disclosure is an organosilicon compound. Use of the selectivity control agent is believed to facilitate production of very high melt flow rate polymers while also producing a polymer product with high bulk density, low fines, and good operability. In one aspect, an organosilicon compound can be used in conjunction with an activity limiting agent, such as pentyl valerate. The selectivity control agent and the activity limiting agent can both be considered external electron donors, forming a mixed external electron donor. The molar ratio of activity limiting agent to selectivity control agent can be from about 40:60 to about 80:20, such as from about 50:50 to about 70:30. The mixed external electron donor may be used to control xylene soluble content, especially at higher hydrogen ratios in the reactor by adding greater amounts of the mixed external electron donor.

In one aspect, the process for producing the polymer can be carried out in a gas phase reactor. The catalyst used according to the process has been found to produce high melt flow rate polymers while still operating at a relatively low hydrogen partial pressure in comparison to past processes. For instance, in one aspect the hydrogen partial pressure within the reactor can be maintained below 60 psi, such as less than about 58 psi. Likewise, lowering the propylene partial pressure during the process can increase the melt flow rate of the polymer being produced.

The reactor temperature can also be controlled and manipulated in order to optimize production of the polymer. For example, in one aspect, the reactor temperature can be from about 68° C. to about 75° C. Alternatively, higher temperatures can be used. For instance, in an alternative embodiment, the reactor temperature can be greater than about 75° C., such as greater than about 80° C., such as greater than about 85° C., such as greater than about 90° C. and generally less than about 95° C. Higher reactor temperatures can increase the hydrogen response and thus enable production of polymers having higher melt flow rates at lower hydrogen concentrations in comparison to operating the reactor at lower temperatures.

In one aspect, the hydrogen ratio to other components in the reactor may be relatively high. As described above, the xylene solubles is controlled by changing the amount of external electron donor present, which is the amount of both the selectivity control agent and activity limiting agent. For higher melt flows with low xylene solubles, more external electron donor may be fed to the reactor. Combining high hydrogen concentration in the presence of the external electron donors and using particular catalyst systems as described below have been found to produce the polymers with ultrahigh melt flow rates.

Through the process of the present disclosure, polypropylene polymers can be produced having a melt flow rate of generally greater than about 900 g/10 min. For instance, the melt flow rate of the polymer can be from about 900 g/10 min to about 9000 g/10 min, such as from about 900 g/10 min to about 7000 g/10 min, including all increments of 5 g/10 min therebetween. In certain aspects, the melt flow rate of the polypropylene polymer can be greater than about 1000 g/10 min, such as greater than about 1200 g/10 min, such as greater than about 1400 g/10 min, such as greater than about 1800 g/10 min, such as greater than about 2200 g/10 min. The polypropylene polymer can be a polypropylene homopolymer. Polypropylene copolymers may also be formed through the process including polypropylene random copolymers and polypropylene block copolymers. Comonomers can include ethylene or butylene.

By using a Ziegler-Natta catalyst system, the polypropylene polymer can be formed having a molecular weight distribution of generally greater than about 2.5. The molecular weight distribution can generally be greater than about 3, such as greater than about 3.5, such as greater than about 4, such as greater than about 4.5, and generally less than about 13, such as less than about 12, such as less than about 10. Maintaining the molecular weight distribution between about 3 and about 10 may provide various advantages when producing nonwoven webs. For example, maintaining the molecular weight distribution within the above range may produce webs that have dimensional stability and do not neck when produced and manipulated.

Polypropylene polymers made according to the present disclosure generally have a controlled xylene soluble content. For example, the polypropylene polymer can have a xylene soluble content of less than about 6%, such as less than about 4.5%, such as less than about 4%, such as less than about 3.5%, such as less than about 3%, such as less than about 2.5%, such as less than about 2%. The xylene soluble content can be greater than about 3%, such as greater than about 4% by weight.

The polypropylene polymer can also have a relatively low molecular weight. The molecular weight as determined from GPC, for instance, can be less than about 100,000 g/mol, such as less than about 80,000 g/mol, such as less than about 70,000 g/mol, and greater than about 10,000 g/mol, such as greater than about 20,000 g/mol, such as greater than about 30,000 g/mol, such as greater than about 40,000 g/mol.

As described above, the polypropylene polymer is Ziegler-Natta catalyzed. The catalyst can include a solid catalyst component that can vary depending upon the particular application.

The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organosilicon compound, and an internal electron donor. In one embodiment, an organic phosphorus compound can also be incorporated into the solid catalyst component. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

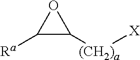

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; α-pinene oxide; 2,3-epoxynorbornane; limonene oxide; cyclodecane epoxide; 2,3,5,6-diepoxynorbornane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl)propane; tris(4-glycidyloxyphenyl)methane; poly(oxypropylene)triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl)methane; poly(N,N-glycidylmethylacrylamide); 1,2-epoxy-3-(diphenylcarbamoyl)cyclohexane; 2,3-epoxy-6-(dimethylcarbamoyl)bicycle[2.2.1]heptane; 2-(dimethylcarbamoyl)styrene oxide; 4-(1,2-epoxybutyl)-4′-(dimethylcarbamoyl)biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl)naphthalene.

As an example of the organic phosphorus compound, phosphate acid esters such as trialkyl phosphate acid ester may be used. Such compounds may be represented by the formula:

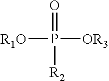

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into nonagglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 15-150 microns, preferably between 20-100 microns, and most preferably between 35-85 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C. Halogenation may be continued in the substantial absence of the internal electron donor for a period from 5 to 60 minutes, or from 10 to 50 minutes.

The manner in which the catalyst component, the halogenating agent and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about 30 minutes, at a temperature from at least about -20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

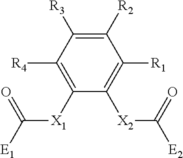

wherein R₁ R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In one aspect, the substituted phenylene diester has the following structure (I):

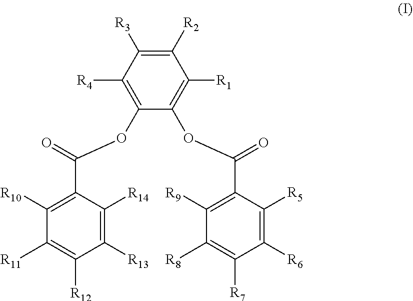

In an embodiment, structure (I) includes R₁ and R₃ that is an isopropyl group. Each of R₂, R₄ and R₅-R₁₄ is hydrogen.

In an embodiment, structure (I) includes each of R₁, R₅, and R₁₀ as a methyl group and R₃ is a t-butyl group. Each of R₂, R₄, R₆-R₉ and R₁₁-R₁₄ is hydrogen.

In an embodiment, structure (I) includes each of R₁, R₇, and R₁₂ as a methyl group and R₃ is a t-butyl group. Each of R₂, R₄, R₅, R₆, R₈, R₉, R₁₀, R₁₁, R₁₃, and R₁₄ is hydrogen.

In an embodiment, structure (I) includes R₁ as a methyl group and R₃ is a t-butyl group. Each of R₇ and R₁₂ is an ethyl group. Each of R₂, R₄, R₅, R₆, R₈, R₉, R₁₀, R₁₁, R₁₃, and R₁₄ is hydrogen.

In an embodiment, structure (I) includes each of R₁, R₅, R₇, R₉, R₁₀, R₁₂, and R₁₄ as a methyl group and R₃ is a t-butyl group. Each of R₂, R₄, R₆, R₈, R₁₁, and R₁₃ is hydrogen.

In an embodiment, structure (I) includes R₁ as a methyl group and R₃ is a t-butyl group. Each of R₅, R₇, R₉, R₁₀, R₁₂, and R₁₄ is an i-propyl group. Each of R₂, R₄, R₆, R₈, R₁₁, and R₁₃ is hydrogen.

In an embodiment, the substituted phenylene aromatic diester has a structure selected from the group consisting of structures (II)-(V), including alternatives for each of R₁ to R₁₄, that are described in detail in U.S. Pat. No. 8,536,372, which is incorporated herein by reference.

In an embodiment, structure (I) includes R₁ that is a methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a fluorine atom. Each of R₂, R₄, R₅, R₆, R₈, R₉, R₁₀, R₁₁, R₁₃, and R₁₄ is hydrogen.

In an embodiment; structure (I) includes R_{I} that is a methyl group and R₃ is a t-butyl group. Each of R₇ and R₁₂ is a chlorine atom. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R12 is a bromine atom. Each of R₂, R₄, R₅, R₆, R₈, R₉, R₁₀, R₁₁, R₁₃, and R₁₄ is hydrogen.

In an embodiment, structure (I) includes R¹ that is a methyl group and R₃ is a t-butyl group. Each of R₇ and R₁₂ is an iodine atom. Each of R₂, R₄, R₅, R₆, R₈, R₉, R₁₀, R₁₁, R₁₃, and R₁₄ is hydrogen.

In an embodiment; structure (I) includes R¹ that is a methyl group and R₃ is a t-butyl group. Each of R₆, R₇, R₁₁, and R₁₂ is a chlorine atom. Each of R₂, R₄, R₅, R₈, R₉, R₁₀, R₁₃, and R₁₄ is hydrogen.

In an embodiment, structure (I) includes R₁ that is a methyl group and R₃ is a t-butyl group. Each of R₆, R₈, R₁₁, and R₁₃ is a chlorine atom. Each of R₂, R₄, R₅, R₇, R₉, R₁₀, R₁₂, and R₁₄ is hydrogen.

In an embodiment, structure (I) includes R₁ that is a methyl group and R₃ is a t-butyl group, Each of R₂, R₄ and R₅-R₁₄ is a fluorine atom.

In an embodiment, structure (I) includes R₁ that is a methyl group and R₃ is a t-butyl group. Each of R₇ and R₁₂ is a trifluoromethyl group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group, Each of R₇ and R₁₂ is an ethoxycarbonyl group. Each of R₂, R₄, R₅, R₆, R₈, R₉, R₁₀, R₁₁, R₁₃, and R₁₄ is hydrogen.

In an embodiment, R₁ is methyl group and R₃ is a t-butyl group. Each of R₇ and R₁₂ is an ethoxy group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a t-butyl group. Each of R₇ and R₁₂ is a diethylamino group. Each of R₂, R₄, R₅, R₆, R₈, R₉, R₁₀, R₁₁, R₁₃, and R₁₄ is hydrogen.

In an embodiment, structure (I) includes R₁ that is a methyl group and R₃ is a 2,4,4-trimethylpentan-2-yl group. Each of R₂, R₄ and R₅-R₁₄ is hydrogen.

In an embodiment, structure (I) includes R₁ and R₃, each of which is a sec-butyl group, Each of R₂, R₄ and R₅-R₁₄ is hydrogen.

In an embodiment, structure (I) includes R₁ and R₄ that are each a methyl group. Each of R₂, R₃, R₅-R₉ and R₁₀-R₁₄ is hydrogen.

In an embodiment, structure (I) includes R₁ that is a methyl group. R₄ is an i-propyl group. Each of R₂, R₃, R₅-R₉ and R₁₀-R₁₄ is hydrogen.

In an embodiment, structure (I) includes R₁, R₃, and R₄, each of which is an i-propyl group. Each of R₂, R₅-R₉ and R₁₀-R₁₄ is hydrogen.

In another aspect, the internal electron donor can be a phthalate compound. For example, the phthalate compound can be dimethyl phthalate, diethyl phthalate, dipropyl phthalate, diisopropyl phthalate, dibutyl phthalate, diisobutyl phthalate, diamyl phthalate, diisoamyl phthalate, methylbutyl phthalate, ethylbutyl phthalate, or ethylpropyl phthalate.

In addition to the solid catalyst component as described above, the catalyst system of the present disclosure can also include a cocatalyst. The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

Suitable catalyst compositions can include the solid catalyst component, a co-catalyst, and an external electron donor that can be a mixed external electron donor (M-EED) of two or more different components. Suitable external electron donors or “external donor” include one or more activity limiting agents (ALA) and/or one or more selectivity control agents (SCA). As used herein, an “external donor” is a component or a composition comprising a mixture of components added independent of procatalyst formation that modifies the catalyst performance. As used herein, an “activity limiting agent” is a composition that decreases catalyst activity as the polymerization temperature in the presence of the catalyst rises above a threshold temperature (e.g., temperature greater than about 95° C.). A “selectivity control agent” is a composition that improves polymer tacticity, wherein improved tacticity is generally understood to mean increased tacticity or reduced xylene solubles or both. It should be understood that the above definitions are not mutually exclusive and that a single compound may be classified, for example, as both an activity limiting agent and a selectivity control agent.

A selectivity control agent in accordance with the present disclosure is generally an organosilicon compound. For example, in one aspect, the selectively control agent can be an alkoxysilane.

In one embodiment, the alkoxysilane can have the following general formula: SiRₘ(OR′)₄₋ₘ(I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may comprise n-propyltriethoxysilane. Other selectively control agents that can be used include propyltriethoxysilane or diisobutyldimethoxysilane.

In one embodiment, the catalyst system may include an activity limiting agent (ALA). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly-(two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C_{4-C30} aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

In one embodiment, the selectivity control agent and/or activity limiting agent can be added into the reactor separately. In another embodiment, the selectivity control agent and the activity limiting agent can be mixed together in advance and then added into the reactor as a mixture. In addition, the selectivity control agent and/or activity limiting agent can be added into the reactor in different ways. For example, in one embodiment, the selectivity control agent and/or the activity limiting agent can be added directly into the reactor, such as into a fluidized bed reactor. Alternatively, the selectivity control agent and/or activity limiting agent can be added indirectly to the reactor volume by being fed through, for instance, a cycle loop. The selectivity control agent and/or activity limiting agent can combine with the catalyst particles within the cycle loop prior to being fed into the reactor.

The catalyst system of the present disclosure as described above can be used for producing olefin-based polymers. The process includes contacting an olefin with the catalyst system under polymerization conditions.

One or more olefin monomers can be introduced into a polymerization reactor to react with the catalyst system and to form a polymer, such as a fluidized bed of polymer particles. The olefin monomer for instance, can be propylene. Any suitable reactor may be used including a fluidized bed reactor, a stirred gas reactor, moving packed bed reactor, a multizone reactor, a bulk phase reactor, a slurry reactor or combinations thereof. Suitable commercial reactors include the UNIPOL reactor, the SPHERIPOL, the SPHERIZONE reactor and the like.

As used herein, “polymerization conditions” are temperature and pressure parameters within a polymerization reactor suitable for promoting polymerization between the catalyst composition and an olefin to form the desired polymer. The polymerization process may be a gas phase, a slurry, or a bulk polymerization process, operating in one, or more than one reactor.

In one embodiment, polymerization occurs by way of gas phase polymerization. As used herein, “gas phase polymerization” is the passage of an ascending fluidizing medium, the fluidizing medium containing one or more monomers, in the presence of a catalyst through a fluidized bed of polymer particles maintained in a fluidized state by the fluidizing medium. “Fluidization,” “fluidized,” or “fluidizing” is a gas-solid contacting process in which a bed of finely divided polymer particles is lifted and agitated by a rising stream of gas. Fluidization occurs in a bed of particulates when an upward flow of fluid through the interstices of the bed of particles attains a pressure differential and frictional resistance increment exceeding particulate weight. Thus, a “fluidized bed” is a plurality of polymer particles suspended in a fluidized state by a stream of a fluidizing medium. A “fluidizing medium” is one or more olefin gases, optionally a carrier gas (such as H₂ or N₂) and optionally a liquid (such as a hydrocarbon) which ascends through the gas-phase reactor.

A typical gas-phase polymerization reactor (or gas phase reactor) includes a vessel (i.e., the reactor), the fluidized bed, a distribution plate, inlet and outlet piping, a compressor, a cycle gas cooler or heat exchanger, and a product discharge system. The vessel includes a reaction zone and a velocity reduction zone, each of which is located above the distribution plate. The bed is located in the reaction zone. In an embodiment, the fluidizing medium includes propylene gas and at least one other gas such as an olefin and/or a carrier gas such as hydrogen or nitrogen.

In one embodiment, the contacting occurs by way of feeding the catalyst composition into a polymerization reactor and introducing the olefin into the polymerization reactor. In an embodiment, the cocatalyst can be mixed with the catalyst composition (pre-mix) prior to the introduction of the catalyst composition into the polymerization reactor. In another embodiment, the cocatalyst is added to the polymerization reactor independently of the catalyst composition. The independent introduction of the cocatalyst into the polymerization reactor can occur simultaneously, or substantially simultaneously, with the catalyst composition feed.

In one embodiment, the polymerization process may include a pre-activation step. Pre-activation includes contacting the catalyst composition with the co-catalyst and the selectivity control agent and/or the activity limiting agent. The resulting preactivated catalyst stream is subsequently introduced into the polymerization reaction zone and contacted with the olefin monomer to be polymerized. Optionally, additional quantities of the selectivity control agent and/or the activity limiting agent may be added.

The process can include mixing the selectivity control agent (and optionally the activity limiting agent) with the catalyst composition. The selectivity control agent can be complexed with the cocatalyst and mixed with the catalyst composition (pre-mix) prior to contact between the catalyst composition and the olefin. In another embodiment, the selectivity control agent and/or the activity limiting agent can be added independently to the polymerization reactor. In one embodiment, the selectivity control agent and/or the activity limiting agent can be fed to the reactor through a cycle loop.

The above process can be used to produce polypropylene polymers having very high melt flow rates. In addition, polymers can be produced having a relatively low amount of fines and having a relatively high bulk density. The bulk density, for instance, can be greater than about 0.30 g/cc, such as greater than about 0.4 g/cc, such as greater than about 0.42 g/cc, such as greater than about 0.45 g/cc. The bulk density is generally less than about 0.6 g/cc, such as less than about 0.5 g/cc, such as less than about 0.4 g/cc.

Polypropylene polymers made according to the present disclosure can then be incorporated into various polymer compositions for producing molded articles. The polymer composition can contain the high melt flow rate polypropylene polymer in an amount generally greater than about 70% by weight, such as in an amount greater than about 80% by weight, such as in an amount greater than about 90% by weight, such as in an amount greater than about 95% by weight. The polymer composition can contain various different additives and ingredients. For instance, the polymer composition can contain one or more antioxidants. For example, in one aspect, the polymer composition can contain a sterically hindered phenolic antioxidant and/or a phosphite antioxidant. The polymer composition can also contain an acid scavenger, such as calcium stearate. In addition, the polymer composition can contain a coloring agent, a UV stabilizer, and the like. Each of the above additives can be present in the polymer composition generally in an amount from about 0.015 to about 2% by weight.

Alternatively, the high melt flow rate polypropylene polymer can be used as a processing aid. A processing aid can be a flow agent for improving the melt flow properties of other polymers, a lubricant, a mold release agent, a wax or the like. In this embodiment, the high melt flow rate polypropylene polymer of the present disclosure can be present in a polymer composition in an amount of from about 2% by weight to about 50% by weight, including all increments of 1 therebetween. For example, the high melt flow rate polypropylene polymer can be present in a polymer composition in an amount less than about 30% by weight, such as less than about 25% by weight, such as less than about 20% by weight, such as less than about 10% by weight, and generally greater than about 5% by weight. Polymers that can be combined with the high melt flow rate polypropylene polymer include other lower melt flow rate polypropylene polymers, polyethylene polymers, polyester polymers, and the like.

The present disclosure may be better understood with reference to the following example.

### EXAMPLE

Various different high melt flow rate polypropylene homopolymers were made in accordance with the present disclosure using two different catalysts, Catalyst A and Catalyst B. Sample Numbers 13 through 18 below were produced using Catalyst B, which is LYNX 1010 catalyst commercially available from the W.R. Grace and Company. The LYNX 1010 catalyst includes a solid catalyst component containing a magnesium moiety, a titanium moiety, an epoxy compound and an organosilicon compound. The LYNX 1010 catalyst includes a phthalate compound as an internal electron donor.

Sample Numbers 1 through 12 and 19 through 21 below were produced using Catalyst A, a similar solid catalyst component but using a non-phthalate substituted phenylene diester internal electron donor.

Both catalyst systems were used in conjunction with a selectively control agent. The selectivity control agent used was propyltriethoxylsilane. The selectivity control agent was used with pentyl valerate as the activity limiting agent. The molar ratio of selectivity control agent to activity limiting agent was 40:60.

The reactor conducted polymerization in a gas-phase fluidized bed with a compressor and cooler connected to a cycle gas line.

Polypropylene resin powder was produced in the fluidized bed reactor using the above catalysts in combination with triethylaluminum (TEAI) as a cocatalyst.

The fluidized bed reactor was operated under the following conditions:
Reactor Temperature: 72° C. for Examples 1 through 17 or 80° C. for Example 18
Bed weight: 68 to 72 lbs
Superficial gas velocity: 1.0 to 1.6 ft/sec

All of the polymers were produced at hydrogen to monomer ratios of from about 0.11 to about 0.23. All of the polymers produced had a xylene soluble content of from 1.5% to 6% by weight and a molecular weight distribution of greater than 2.5. Catalyst productivity was in the range from 10 to 40 ton/kg of catalyst and averaged around 20 ton/kg. The ultra-high melt flow rate polymers were produced without having to use a peroxide. The polymer particle sizes were determined using the GRADEX sieve test.

The following samples were produced and the following results were obtained:

TABLE 3

| | | TEAI/ | | | | | | | | |
|---|---|---|---|---|---|---|---|---|---|---|
| | | External | Melt | Xylene | | | | | | |
| | | Donor | Flow | Solubles- | | | | | | |
| | H2/C3 | Molar | Rate | Wet | Catalyst | | | | | |
| Sample | Molar | Feed | (g/10 | Method | Productivity | Mw | Mn | Mw/ | Mz | Mz + 1 |
| No. | Ratio | Ratio | min) | (wt %) | (kg/kg) | (g/mol) | (g/mol) | Mn | (g/mol) | (g/mol) |
| 1 | 0.1640 | 9.25 | 3477 | 5.43 | 39,919 | | | | | |
| 2 | 0.1127 | 3.95 | 919 | 2.85 | 33,000 | 75,200 | 8,500 | 8.9 | 323,900 | 977,700 |
| 3 | 0.1162 | 3.10 | 1590 | 2.48 | 32,566 | 72,700 | 8,000 | 9.1 | 337,300 | 1,040,200 |
| 4 | 0.1165 | 3.21 | 1532 | 3.45 | 38,077 | 75,000 | 8,200 | 9.2 | 343,700 | 1,036,300 |
| 5 | 0.1158 | 2.45 | 1411 | 1.64 | 25,000 | 75,000 | 8,200 | 9.2 | 334,800 | 977,200 |
| 6 | 0.1360 | 2.54 | 1938 | 2.50 | 22,098 | 70,100 | 7,500 | 9.4 | 344,000 | 1,078,300 |
| 7 | 0.1679 | 1.97 | 2461 | 1.92 | 16,071 | | | | | |
| 8 | 0.1679 | 2.05 | 2560 | 2.45 | 16,723 | | | | | |
| 9 | 0.1680 | 1.95 | 2782 | 2.43 | 15,184 | | | | | |
| 10 | 0.1673 | 1.95 | 2613 | 2.43 | 15,184 | 64,800 | 6,700 | 9.7 | 343,000 | 1,115,600 |
| 11 | 0.1679 | 2.02 | 2307 | 2.55 | 17,553 | | | | | |
| 12 | 0.1772 | 2.02 | 2511 | 1.92 | 11,149 | | | | | |
| 13 | 0.1616 | 4.02 | 1008 | 2.52 | 12,402 | 72,600 | 7,900 | 9.2 | 288,200 | 857,500 |
| 14 | 0.2196 | 4.95 | 1514 | 2.50 | 12,402 | 69,700 | 7,800 | 9 | 251,600 | 722,500 |
| 15 | 0.1700 | 6.08 | 1108 | 3.12 | 25,301 | | | | | |
| 16 | 0.1703 | 6.23 | 1509 | 5.42 | 23,333 | 91,900 | 7,600 | 12 | 570,700 | 1,639,800 |
| 17 | 0.1733 | 4.04 | 1204 | 3.78 | 24,138 | | | | | |
| 18 | 0.2049 | 5.16 | 2066 | 2.52 | 14,858 | 61,800 | 7,800 | 7.9 | 206,200 | 625,200 |

TABLE 4

| | Melt | | | | | | | | | | |
|---|---|---|---|---|---|---|---|---|---|---|---|
| | Flow | | GRADEX | GRADEX | GRADEX | GRADEX | GRADEX | GRADEX | | Settled | Average |
| | Rate | GRADEX | 10 | 18 | 35 | 60 | 120 | 200 | GRADEX | Bulk | Particle |
| Sample | (g/10 | Fines | Mesh | Mesh | Mesh | Mesh | Mesh | Mesh | Pan | Density | Size |
| No. | min) | (wt %) | (wt %) | (wt %) | (wt %) | (wt %) | (wt %) | (wt %) | (wt %) | (g/cm3) | (mm) |
| 1 | 3477 | 9.7 | 0.0 | 0.2 | 13.1 | 45.8 | 31.1 | 7.6 | 2.1 | 0.35 | 0.32 |
| 2 | 919 | 4.5 | 0.0 | 0.1 | 19.6 | 52.5 | 23.4 | 3.5 | 0.9 | 0.35 | 0.37 |
| 3 | 1590 | 5.0 | 0.0 | 0.0 | 20.2 | 51.0 | 23.8 | 3.7 | 1.3 | 0.35 | 0.37 |
| 4 | 1532 | 4.3 | 0.0 | 0.1 | 20.4 | 51.6 | 23.5 | 3.5 | 0.9 | 0.35 | 0.37 |
| 5 | 1411 | 5.5 | 0.0 | 0.1 | 19.3 | 52.6 | 22.5 | 3.7 | 1.8 | 0.35 | 0.37 |
| 6 | 1938 | 5.4 | 0.0 | 0.0 | 19.1 | 52.6 | 22.9 | 3.6 | 1.8 | 0.35 | 0.37 |
| 7 | 2461 | 6.3 | 0.0 | 0.0 | 3.3 | 63.3 | 27.1 | 4.4 | 1.9 | 0.35 | 0.30 |
| 8 | 2560 | 6.1 | 0.0 | 0.0 | 1.5 | 63.2 | 29.3 | 4.5 | 1.6 | 0.34 | 0.29 |
| 9 | 2782 | 5.9 | 0.0 | 0.0 | 1.6 | 63.3 | 29.1 | 4.3 | 1.6 | 0.34 | 0.29 |
| 10 | 2613 | 5.9 | 0.0 | 0.0 | 1.6 | 63.3 | 29.1 | 4.3 | 1.6 | 0.34 | 0.29 |
| 11 | 2307 | 6.7 | 0.0 | 0.0 | 1.9 | 60.7 | 30.7 | 5.1 | 1.6 | 0.35 | 0.29 |
| 12 | 251 | 7.2 | 0.0 | 0.0 | 1.2 | 62.3 | 29.3 | 5.2 | 1.9 | 0.36 | 0.28 |
| 13 | 1008 | 5.8 | 0.0 | 0.1 | 17.0 | 63.3 | 13.7 | 2.5 | 3.3 | 0.34 | 0.37 |
| 14 | 1514 | 4.0 | 0.0 | 0.1 | 22.9 | 60.5 | 12.5 | 2.3 | 1.7 | 0.34 | 0.40 |
| 15 | 1108 | 4.9 | 0.0 | 0.1 | 49.2 | 38.5 | 7.4 | 2.5 | 2.4 | 0.36 | 0.50 |
| 16 | 1509 | 3.9 | 0.0 | 0.1 | 38.9 | 49.5 | 7.6 | 1.9 | 2.0 | 0.36 | 0.47 |
| 17 | 1204 | 3.5 | 0.1 | 0.1 | 34.6 | 54.1 | 7.6 | 1.9 | 1.6 | 0.36 | 0.45 |
| 18 | 2066 | 6.1 | 0.0 | 0.1 | 11.4 | 68.0 | 14.4 | 2.8 | 3.3 | 0.36 | 0.35 |

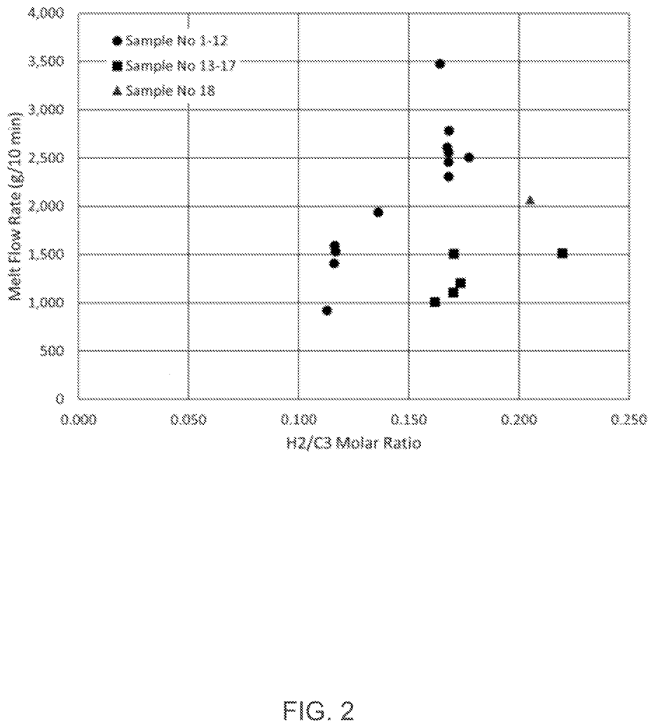

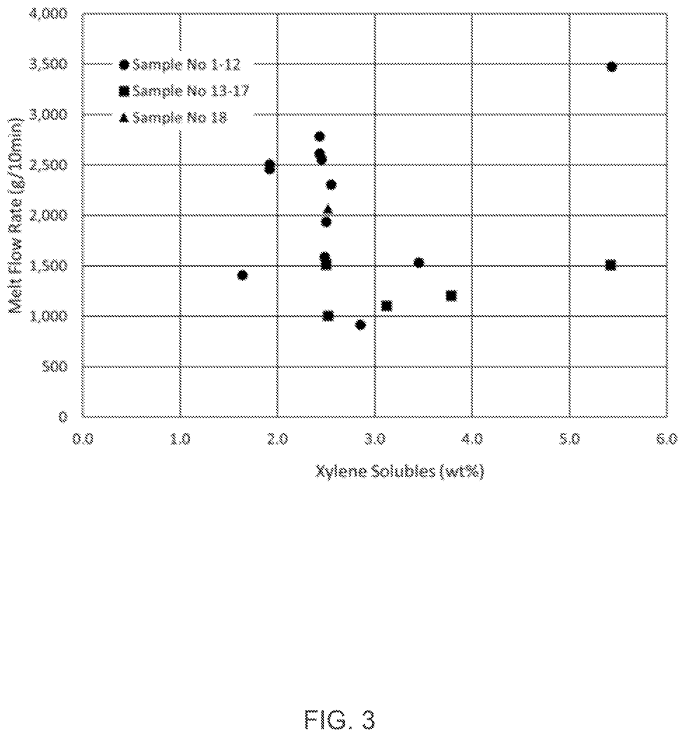

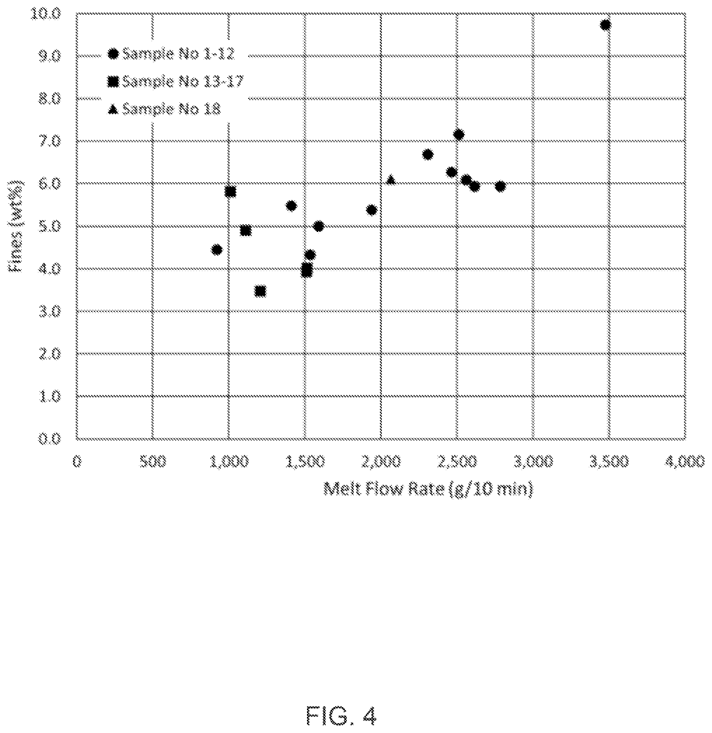

As shown above, all of the samples had a melt flow rate of greater than 900 g/10 min with the highest melt flow being 8,152 g/10 min. The results are also illustrated in FIGS. 2 through 4. As shown in FIG. 4, the amount of fines produced during the process was relatively low.

As shown above, higher reactor temperature is beneficial. Sample 18 was produced at 80° C. whiles samples 1-17 were produced at 72° C. Comparing examples 14 and 18, the molecular weight distribution (MWD) and Mw are both lower when reactor temperature is higher while the melt flow rate is higher yet the hydrogen ratio is kept at about the same.

Further samples were made at higher reactor temperature with Catalyst A, as shown in the table below.

TABLE 5

| | | | TEAI/ | | | |
|---|---|---|---|---|---|---|
| | | | External | Melt | Xylene | |
| | Reactor | | Donor | Flow | Solubles- | |
| | Temper- | H2/C3 | Molar | Rate | Wet | Catalyst |
| Sample | ature | Molar | Feed | (g/10 | Method | Productivity |
| No. | (° C.) | Ratio | Ratio | min) | (wt %) | (kg/kg) |
| 19 | 80 | 0.109 | 9.17 | 1600 | 3.0 | 48,571 |
| 20 | 90 | 0.098 | 9.21 | 1754 | 3.1 | 56,667 |
| 21 | 90 | 0.198 | 9.86 | 8152 | 4.6 | 60,714 |

Material made with both catalyst A and B was evaluated on a melt blown line to produce fibers with average fiber diameters as shown in Table 6:

TABLE 6

| | | Melt Flow Rate | Melt Blown Fiber Avg. |
|---|---|---|---|
| Sample No. | Catalyst | (g/10 min) | Diameter (micron) |
| 3 | A | 1590 | 3.2 |
| 14 | B | 1514 | 2.4 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention as further described in such appended claims.

1. A polymer composition comprising:
a polypropylene polymer, the polypropylene polymer having a melt flow rate of greater than about 900 g/10 min, the polypropylene polymer having a molecular weight distribution of greater than about 3 and less than about 13, the polypropylene polymer being free of any peroxides.

2. The polymer composition of claim 1, wherein the polypropylene polymer has a melt flow rate of from about 1000 g/10 mins to about 7000 g/10 min.

3-5. (canceled)

6. The polymer composition of claim 1, wherein the polypropylene polymer is a polypropylene homopolymer, a polypropylene random copolymer, or a polypropylene block copolymer.

7. The polymer composition of claim 1, wherein the polypropylene polymer has a xylene solubles content of less than about 6.0% by weight.

8. (canceled)

9. The polymer composition of claim 1, wherein the polypropylene polymer has been Ziegler-Natta catalyzed.

10. (canceled)

11. The polymer composition of claim 1, wherein the polypropylene polymer is contained in the composition in an amount greater than about 70% by weight.

12. The polymer composition of claim 1, wherein the polypropylene polymer comprises a processing aid combined with at least one other polymer having a lower melt flow rate, the polypropylene polymer being contained in the composition in an amount less than about 50% by weight.

13. The polymer composition of claim 12, wherein the polypropylene polymer comprises a wax, a lubricant, a mold release agent or a flow aid.

14. The polymer composition of claim 1, wherein the polypropylene polymer has been catalyzed in the presence of a Ziegler-Natta catalyst, the Ziegler-Natta catalyst comprising a solid catalyst component, a selectively control agent, and optionally an activity limiting agent, the solid catalyst component comprising a magnesium moiety, a titanium moiety, and an internal electron donor.

15-17. (canceled)

18. A fiber made from the polymer composition of claim 1, the fiber having a diameter of less than about 5 microns.

19. A meltblown web comprised of nonwoven, meltblown fibers, the meltblown fibers being made from the polymer composition of claim 1.

20. A process for producing a polypropylene polymer comprising: polymerizing a propylene monomer in the presence of a Ziegler-Natta catalyst, the Ziegler-Natta catalyst including a solid catalyst component, a selectively control agent, and optionally an activity limiting agent, the solid catalyst component comprising a magnesium moiety, a titanium moiety and an internal electron donor, the selectively control agent comprising an organosilicon compound, and wherein a polypropylene polymer is formed having a melt flow rate of greater than about 900 g/10 min, and wherein no peroxides are used during the process to form the polypropylene polymer.

21. The process of claim 20, wherein the solid catalyst component further comprises an organosilicon compound and an epoxy compound.

22. (canceled)

23. The process of claim 1, wherein the selectively control agent comprises an organosilicon compound, and wherein a polypropylene polymer is formed having a melt flow rate of greater than about 1000 g/10 min.

24. The process of claim 20, wherein the polypropylene polymer is a polypropylene homopolymer having a xylene soluble content of less than about 4.5%.

25. The process of claim 20, wherein an H2/C3 molar ratio during polymerization is between about 0.1 and about 0.3.

26. The process of claim 20, wherein a cocatalyst and the external electron donor are fed to the polymerization reactor at a molar ratio of about 1.5 to about 15.

27. (canceled)

28. The process of claim 20, wherein the temperature is increased in order to increase the melt flow rate.

29. The process of claim 20, wherein the resulting polymer is a polypropylene random copolymer or a polypropylene block copolymer containing ethylene or butylene as a comonomer.

30. The process of claim 20, where the propylene partial pressure is reduced in order to increase the melt flow rate of the polypropylene polymer.
